(19) United States
(12) Patent Application Publication
(10) Pub. No.: US 2012/0223791 A1
(43) Pub. Date: Sep. 6, 2012

(54) WEIGHT CONTROL SYSTEM

(76) Inventors: Ki Il KIM, L.A., CA (US); Young K. KIM, L.A., CA (US); Jong Ho LEE, Cerritos, CA (US); Tae Wook KWON, Rowland Heights, CA (US); Gui Hyeon MOON, Buena Park, CA (US)

(21) Appl. No.: 13/172,468

(22) Filed: Jun. 29, 2011

Related U.S. Application Data
(60) Provisional application No. 61/464,430, filed on Mar. 4, 2011.
(60) Provisional application No. 61/516,817, filed on Apr. 8, 2011.

(51) Int. Cl. H01F 7/10

(52) U.S. Cl. 335/228

(57) ABSTRACT

Provided is a weight control system that can include: an upper plate positioned in a lower portion of the system; at least one of, a first magnet or a first electromagnet, configured to be concentrically engaged with the upper plate; an upper internal core; a coil; and an upper plate housing configured to receive the upper internal core and the coil, the upper plate housing being coupled to at least one of, the first magnet or the first electromagnet, wherein, when power is supplied to the system, an induced current is generated in the upper internal core and the coil to create a first centrifugal magnetic field configured to rotate the upper plate and at least one of, the first magnet or the first electromagnet.

### CROSS-REFERENCE TO RELATED APPLICATIONS

This application claims the benefit under 35 U.S.C. Section 119(e) of U.S. Provisional Application Ser. No. 61/464,430, filed Mar. 4, 2011, and U.S. Provisional Application Ser. No. 61/516,817, filed Apr. 8, 2011, the disclosures of which are hereby incorporated by reference in their entireties.

### BACKGROUND OF THE INVENTION

1. Field of the Invention

The present invention relates to a weight control system in which weight energy of an object is partially converted into compression energy by using a spring while the weight energy is absorbed to be converted into other form of energy including, for example, electrical energy or mechanical energy depending on usage for recycling purposes.

2. Description of the Related Art

Generally, in order to reduce the weight of an object, various techniques can be used such as separating an unnecessary part to be removed (e.g., separation of moist from dried sludge) evaporating a part or all of the object to render the weight light (e.g., conveying water in the form of steam), using light material to create buoyancy (e.g., aeroscraft, a balloon, etc.), or using buoyancy assisted lift (e.g., ships, airplanes, etc.). In this manner, weight reduction effect can be achieved although the volume of the object can be increased when the object is vaporized under a high temperature. However, vaporization is advantageous in that it is easy to convey the vaporized object, e.g., water vapor.

However, it is impossible to reduce mass itself because the mass, unlike weight, is invariable. Meanwhile, weight is expressed as W=(mass)×(acceleration of gravity), wherein the acceleration of gravity is 9.8 m/sec². Therefore, it is necessary to reduce the acceleration of gravity to reduce the weight. However, the gravitational acceleration cannot be reduced unless the mass of the earth is reduced or the object moves to a high altitude, i.e., a far distance away from the center of the earth. Therefore, the gravitational acceleration cannot be reduced itself. Instead, a gravity force can be offset by using other source of force such as magnetic or electromagnetic field.

In other words, it is possible to control the weight of the object by partially converting weight energy thereof into other type of energy.

Namely, in order to offset the gravity force, a different source of force such as, for example, magnet, electromagnet, a hydraulic cylinder, a vacuum cylinder, lift, or buoyancy can be used. Herein, the present invention employs a method of using a magnet and an electromagnet, which shows excellent efficiency in offsetting the gravity force.

According to the present invention, a current logistics system can be radically improved as well as enormous future demands can be created from private, public and military sectors.

### SUMMARY OF THE INVENTION

The present invention has been made in view of the above problems, and provides a system for converting weight energy into compression energy of a spring by using a pressure having a predetermined level through sequential steps to achieve an effect of substantially reducing the weight of an object, thereby reducing a transportation cost of the object due to decreased shipping weight as well as providing a solution to a need for developing alternative energy sources.

According to one aspect of the present invention, provided is a weight control system comprising: at least one of, a first magnet or a first electromagnet, configured to be concentrically engaged with an upper plate positioned in a lower portion; and an upper plate housing configured to receive an upper internal core and a coil, the upper plate housing being coupled to the at least one of, the first magnet or the first electromagnet, wherein, when a power is supplied to the system, an induced current is generated in the upper internal core and the coil to create a centrifugal magnetic field configured to rotate the upper plate and the at least one of, the first magnet or the first electromagnet.

According to another aspect of the present invention, provided is a weight control method using a natural frequency of resonance, the method comprising: generating two or more magnetic fields having different directions, wherein the two or more magnetic fields interrupt and overlap each other to generating an upward force; and controlling a weight of an object by applying the upward force to a spring to lift the weight.

### BRIEF DESCRIPTION OF THE DRAWINGS

The objects, features and advantages of the present invention will be more apparent from the following detailed description in conjunction with the accompanying drawings, in which:

FIG. 1 is a front view of a weight control system according to an exemplary embodiment of the present invention;

FIG. 2 is a top down view of the weight control system according to the exemplary embodiment of the present invention;

FIG. 3 is a perspective view of the weight control system according to the exemplary embodiment of the present invention;

FIG. 4 is a perspective view of an weight control apparatus of the weight control system according to an exemplary embodiment of the present invention;

FIG. 5 is a cross-sectional view taken along line A-A of FIG. 2 of the weight control system according to the exemplary embodiment of the present invention;

FIG. 6 is a cross-sectional view taken along line B-B of FIG. 5 of the weight control system according to the exemplary embodiment of the present invention;

FIG. 7 is a cross-sectional view taken along line C-C of FIG. 5 of the weight control system according to the exemplary embodiment of the present invention;

FIG. 8 is a cross-sectional view taken along line D-D of FIG. 5 of the weight control system according to the exemplary embodiment of the present invention;

FIG. 9 is a cross-sectional view taken along line E-E of FIG. 5 of the weight control system according to the exemplary embodiment of the present invention; and

FIG. 10 is a cross-sectional view taken along line F-F of FIG. 5 of the weight control system according to the exemplary embodiment of the present invention.

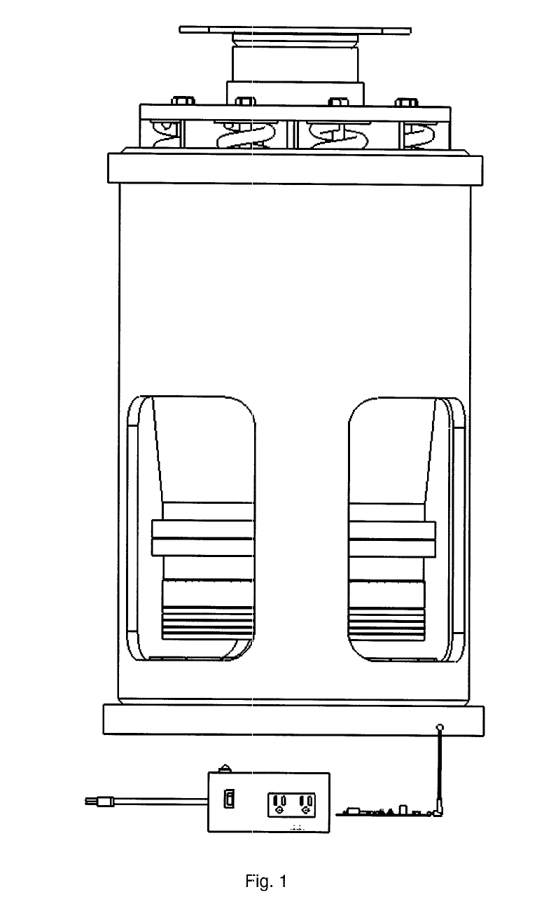

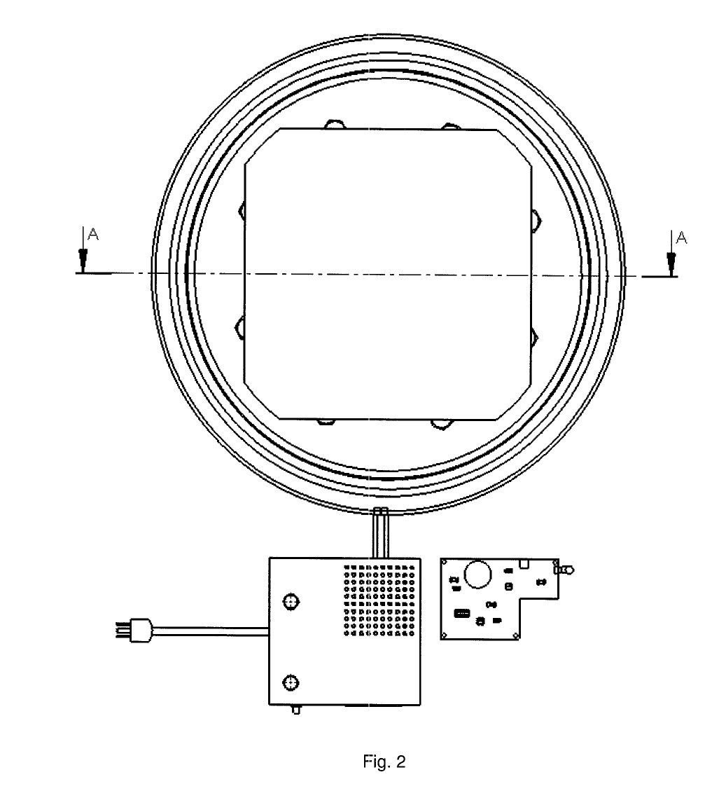

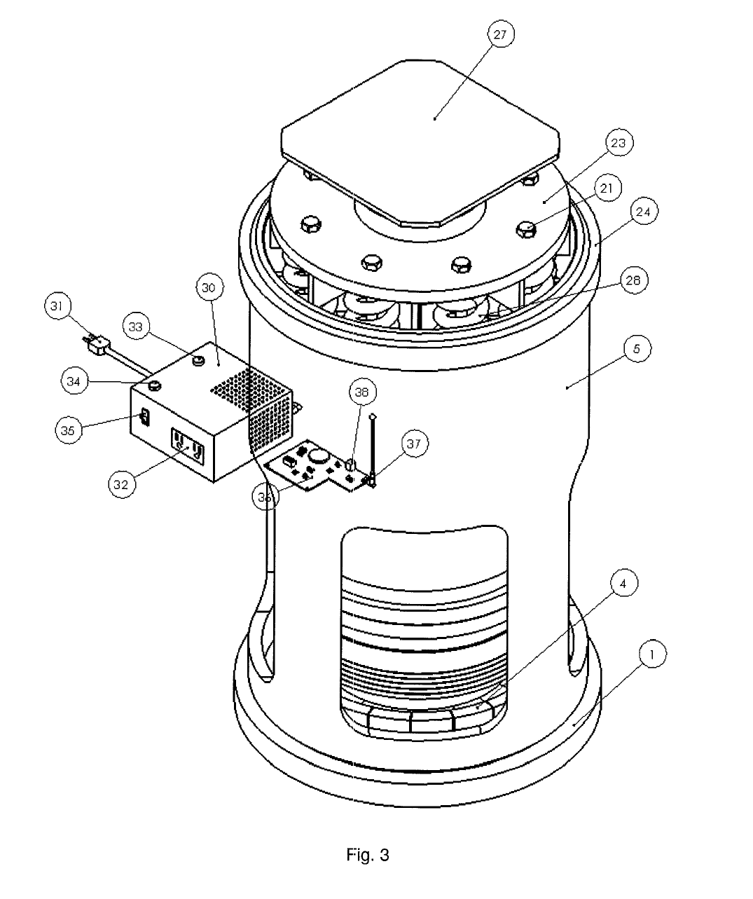

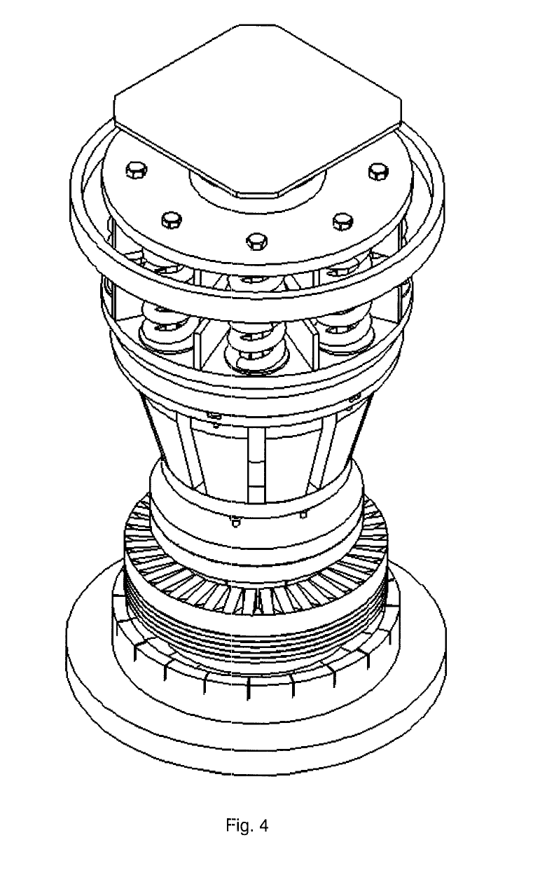

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

In a magnetic circuit including a permanent magnet, the permanent magnet has a permeance coefficient in a range from zero to infinity and its operating point is located on a demagnetization curve in a second quadrant, as shown in FIG. 11. When the magnetic circuit including the permanent magnet has the configuration shown in FIG. 12, the permeance coefficient for predicting and calculating the operating point of the permanent magnet is obtained by a method described below.

The term “magnet/electromagnet,” used herein, refers to at least one of magnet or electromagnet that creates a magnetic or electromagnetic field.

For illustrative purposes, it is assumed that, in the magnetic circuit in FIG. 12, a magnetic flux density and a magnetic field are uniform, a cross sectional area and a length are constant, and a magnetic characteristic of a magnet, i.e., magnetic permeability, is constant. According to Ampere's circuital law, a magnetomotive force of the magnetic circuit is expressed as the following Equation 1 and can be rewritten as the following Equation 3 by using a magnetomotive force loss coefficient f, which is expressed as the following Equation 2.

HₘIₘ+H_{c}I_{c}+H_{g}I_{g}+0 [Equation 1]

HₘIₘ/H_{g}I_{g}=f [Equation 2]

Hₘ=−f(I_{g}/Iₘ)H_{g} [Equation 3]

Meanwhile, Equation 4 in the below can be deduced from magnetic flux continuity condition of the magnetic circuit including the permanent magnet and Equation 6 can be deduced by using a magnetic flux leakage coefficient expressed in Equation 5.

BₘAₘ=B_{g}A_{g}+Φ₁ [Equation 4]

σ₁=BₘAₘ/B_{g}A_{g} [Equation 5]

Bₘ=σ₁(A_{g}/Aₘ)B_{g} [Equation 6]

Based on the Equations 3 and 6 in the above, the permeance coefficient for determining the operating point of the permanent magnet can be obtained as the following Equation 7.

Bₘ/Hₘ=−(σ₁/f)(A_{g}/Aₘ)(lₘ/l_{g})=p_{c} [Equation 7]

Thus, the permeance coefficient is inverse proportionate to the magnetomotive force loss coefficient f and is proportionate to the magnetic flux leakage coefficient σ₁, and is expressed with a function of the cross sectional area and the length of the permanent magnet and a pore. As shown in Figure a, the operating point of the permanent magnet in the magnet circuit is determined as a crossing point of a straight line of the permeance coefficient, p_{c}, and the demagnetization characteristic curve of the permanent magnet. When the magnetic flux density at the operating point is determined, a void magnetic flux density can be calculated by using Equation 6.

However, in reality, it is difficult to calculate the magnetomotive force loss coefficient for the magnetic flux leakage coefficient σ₁ of an electronic appliance in consideration of magnetic saturation. Therefore, a numerical analysis such as a finite element method can be used. The operating point of the permanent magnet can be varied depending on the existence of a reaction magnetic field externally applied or operating temperature, even if the permeance coefficient is constant.

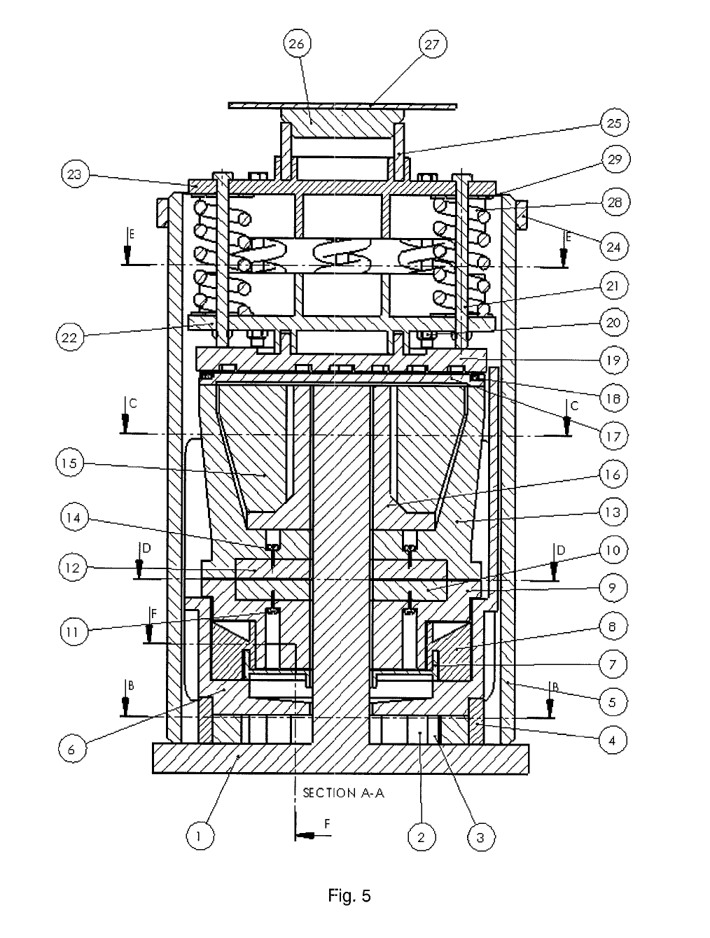

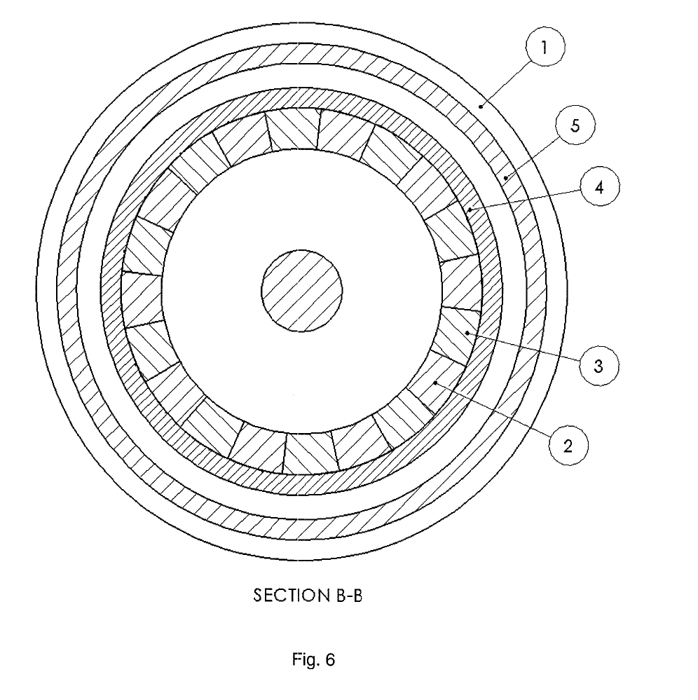

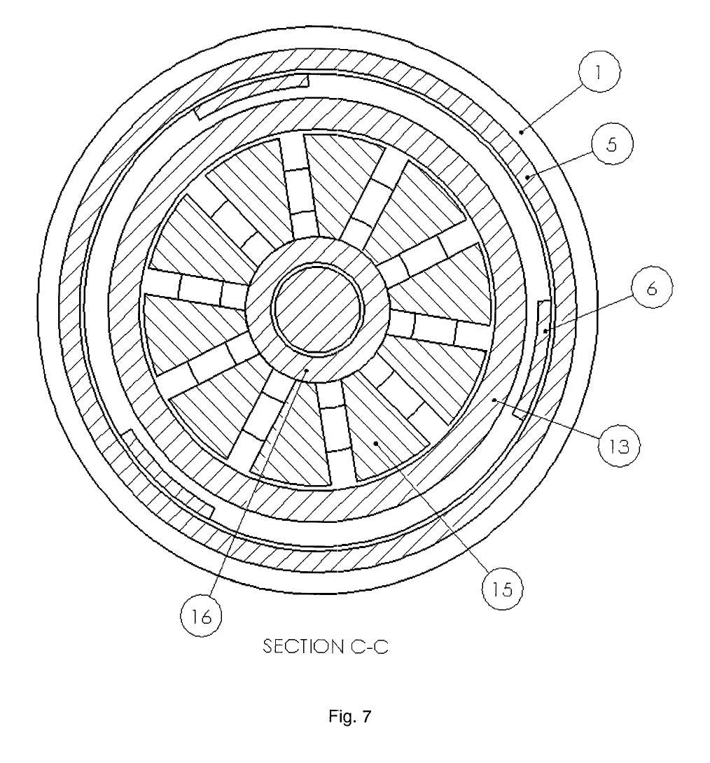

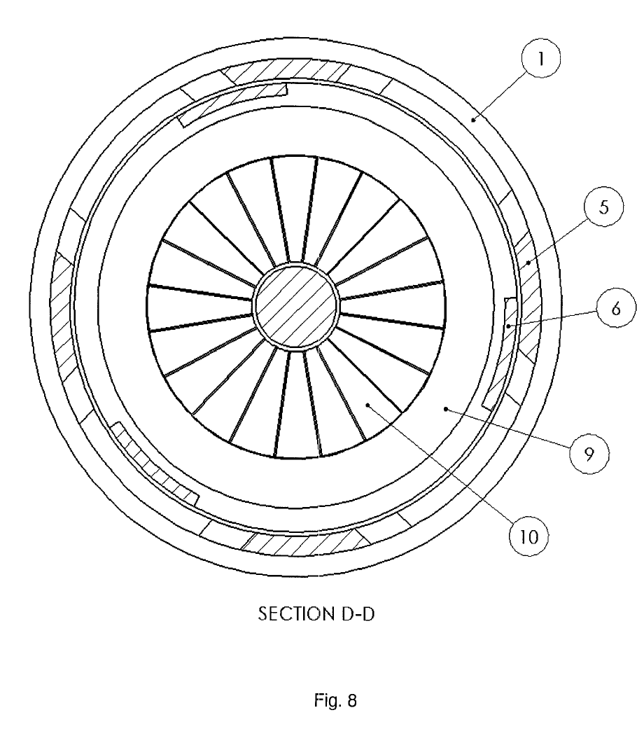

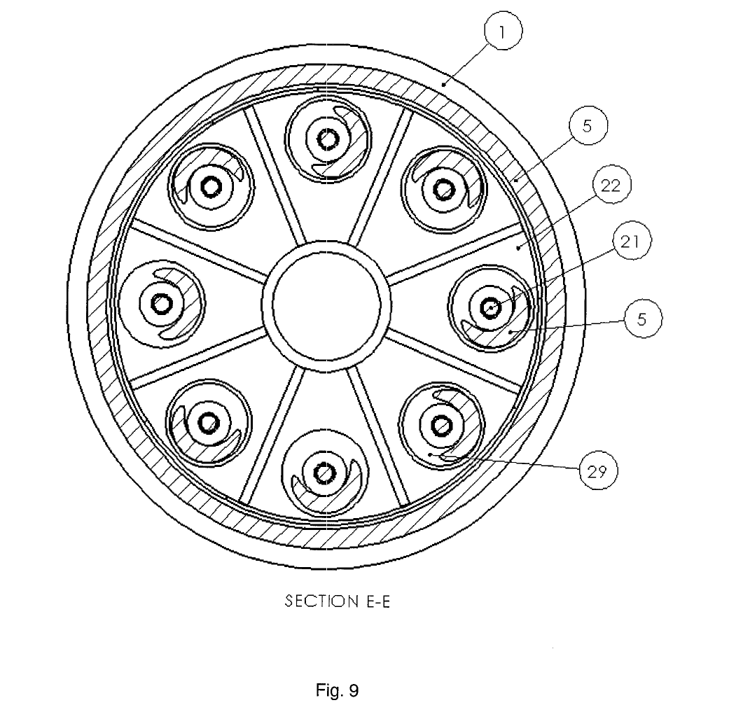

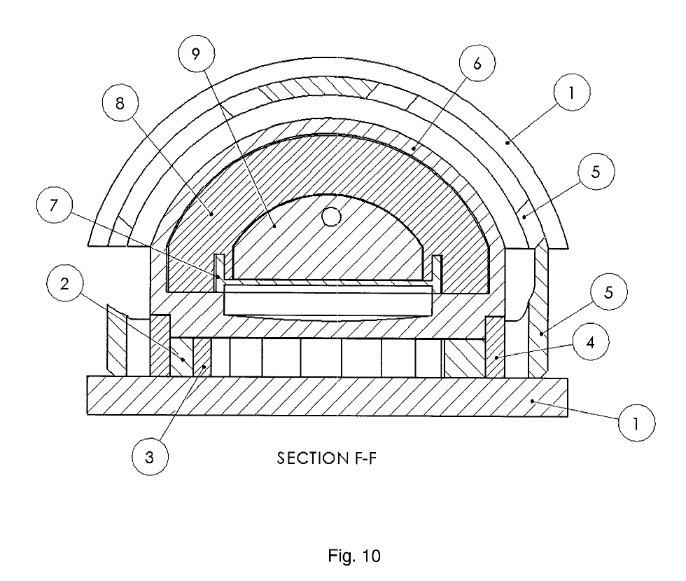

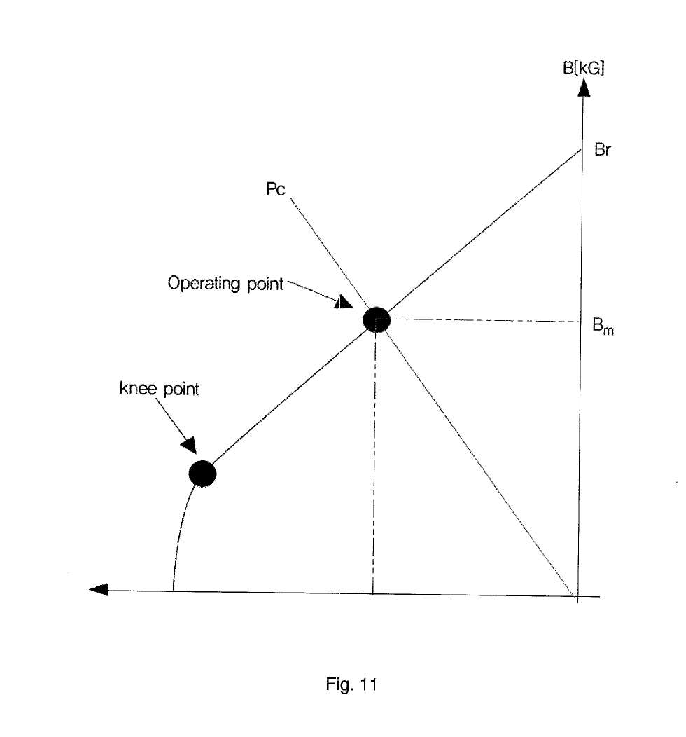

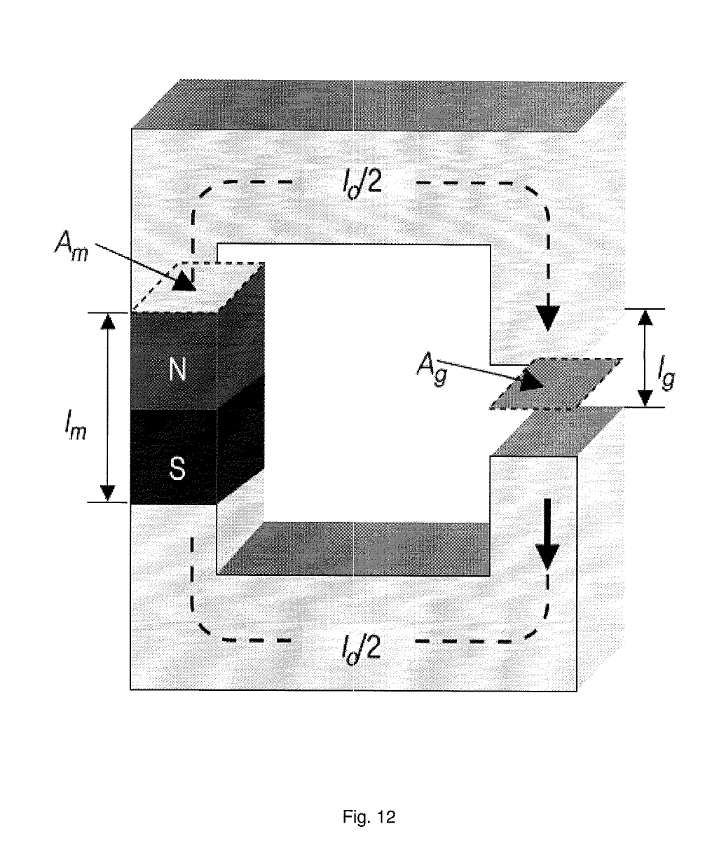

Considering the above characteristics, the system can have a detailed configuration as shown in FIG. 5 by properly arranging the displacement of the magnet and the electromagnet, and considering the strength of magnetic field. When a power is supplied in an initial state to the system configured as shown in FIG. 5, an induced current is generated in an internal core 16 and a coil 15, and a strong and centrifugal magnetic field is generated between a pillar portion of a bottom plate 1 and a second upper plate magnet/electromagnet 12 and an upper plate housing 13, wherein the magnetic field is applied in a downward direction along the pillar portion of the bottom plate 1 and in a direction perpendicular to a centrifugal force. Due to forces produced by the magnetic field applied in two directions, an upper plate 9 and a first upper plate magnet/electromagnet 10, which are positioned in a lower portion of the system, are caused to rotate in the magnetic field, similarly to an operation of an automatic transmission of an automobile. Here, a first magnet/electromagnet 2, which is a complex magnetic flux, and a second magnet/electromagnet 3, a third circular magnet/electromagnet 4 and a bottom base 6, and a spindle 7 and a spindle cover 8 are engaged with each other to rotate, thereby generating a strong centrifugal magnetic field in an opposite direction.

Any object has its own natural frequency, which is a rate at which the object resonates, and the natural frequency of the object is determined according to its stiffness and mass. Specifically, the natural frequency is expressed as ½π (stiffness/mass)½. Therefore, when the stiffness is increased four times, the natural frequency is increased twice, and when the mass is increased four times, the natural frequency is decreased twice. When the natural frequency of the object matches with an outside frequency, the object can be significantly distorted. The present invention utilizes such phenomenon in a magnetic field.

When the two magnetic fields generated in the system engage and interrupt each other, overlapping of the magnetic fields occurs such that an upper cover 17 is lifted by a repulsive force caused by the respective magnetic fields of an upper portion and a lower portion of the system. Therefore, a lifting force is applied to the assembly of an upper spring guide fixing plate 23, a compression spring 28, a compression spring washer 29, a lower spring guide fixing plate 22, a fixing bolt 21 positioned between the upper spring guide fixing plate 23 and the compression spring 28, a fixing nut 20 between the lower spring guide fixing plate 22 and the compression spring 28, and an upper damper 19. Accordingly, the spring begins to be compressed and gradually enters to an anti-gravity state.

When a compression force is applied to a part of the weight control system, the compression force is conveyed to an external through an upper portion piston 25, a piston cap 26, and an external fixing plate 27, thereby reaching a target weight of the object. By repeating the above operation, a desired weight of the object can be achieved.

Thus, according to the present invention, the compression energy of the spring is partially converted into an electrical energy to be recycled based on the weight energy contained in the object. Alternatively, the compression energy of the spring can be converted into a mechanical energy depending on usage.

A piezoelectric element is attached to the upper damper 19 to produce electrical energy based on mechanical vibration applied thereto and the compression energy of the spring. In this manner, when the upper cover 17 is lifted to apply pressure to the upper damper 19, the piezoelectric element attached to the upper damper 19 produces electricity due to stress applied thereto.

In addition, a central processing unit (CPU) that is built in a system control box 30 of FIG. 3 automatically controls an electric power level such that, when an electric power needs to be charged in the system, a red LED light is turned on, a warning sound is generated, and power begins charging. Also, a text, an e-mail or a voice message can be sent to a mobile phone designated by a user or any other reachable device to notify the user of the power charging of the system. Further, the system can be remotely controlled so that the user can operate the system at a desired time. When the power charging of the system is completed, a green LED light is turned on, a system motor stops operating, and the text, the e-mail or the voice message is sent to the mobile phone designated by the user or any other reachable device to notify the user of the completion of the power charging of the system. Therefore, the operation of the system can be monitored at any time and from any place. Further, the user has an option to choose whether to operate the system depending on necessity.

To this end, the system control box 30 includes a power plug 31, a power jack 32, a charge green light 33, a charge red light 34, a switch 35, a printed circuit board (PCB) 36 for the CPU, an antenna 37 and an external connection jack 38.

Materials consisting of each element of the weight control system are described below.

The first magnet/electromagnet 2, which is a complex magnetic flux, the second magnet/electromagnet 3, and the third circular magnet/electromagnet 4, each of which is positioned on the bottom plate 1, preferably comprise a material having strong magnetism. The bottom base 6, the spindle 7 and the spindle cover 8 preferably comprise a material of which property including stiffness and solidity is not changed by a rotational force at a certain level applied thereto. The upper plate 9, the first upper plate magnet/electromagnet 10, the second upper plate magnet/electromagnet 12, and the upper plate housing 13 also preferably comprise a material having strong magnetism.

The upper internal core 16, the coil 15 and the upper cover 17 preferably comprise a material that has higher heat resistance and higher heat conduction and can endure a strong magnetic field. The upper spring guide fixing plate 23, the lower spring guide fixing plate 22, a housing rib 24, the upper piston 25, the piston cap 26, and an external fixing plate 27 are exposed to an external impact, and therefore, a material having higher abrasion resistance, higher hardness and higher elasticity can be used.

The upper damper 19 preferably comprises a rubber material that is compressible and elastic in order to prevent damage to a lower part of the system. In other words, it is desirable that the upper damper 19 has high resistance to shock.

A method of assembling the weight control system according to an exemplary embodiment of the present invention is described below.

In FIG. 5, the first magnet/electromagnet 2, which can generate a complex magnetic flux, and the second magnet/electromagnet 3 are coupled to the bottom plate 1. In other words, the first magnet/electromagnet 2 and the second magnet/electromagnet 3 are assembled to be arranged concentrically about the bottom plate 1. In the outside thereof, the third circular magnet/electromagnet 4 is assembled to generate a magnet field of a certain level. On the top thereon, the bottom base 6 is assembled and the spindle 7 and the spindle cover 8 are assembled by engaging each other.

The upper plate 9 and the first upper plate magnet/electromagnet 10 are fixed to each other by using a fixing bolt 11 positioned therebetween. Also, the second upper plate magnet/electromagnet 12 and the upper plate housing 13 are engaged with each other by using a fixing bolt 14 positioned therebetween, wherein the arrangement is concentric with respect to the assembly of the upper plate 9 and the first upper plate magnet/electromagnet 10. The assembly of a lower electric electromagnet portion is completed by assembling the upper plate internal core 16 and the coil 15 and by engaging the upper cover 17 with the upper plate housing 13 by using a fixing bolt 18 positioned therebetween.

The assembly of an upper buffering part of the system includes the upper spring guide fixing plate 23, the compression spring 28, and the compression spring washer 29 that are assembled together in a radar shape, the lower spring guide fixing plate 22, the fixing bolt 21 positioned between the upper spring guide fixing plate 23 and the compression spring 28, the fixing nut 20 positioned between the lower spring guide fixing plate 22 and the compression spring 28, and the upper damper 19 that is mounted to prevent damage to a lower portion of the system. On the top thereon, the housing rib 24, the upper portion piston 25, and the piston cap 26 are assembled in a consecutive order, and the external fixing plate 27 is mounted thereon. A housing 5 is mounted to finish the external appearance of the assembly.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A weight control system comprising:
an upper plate positioned in a lower portion of the system;
at least one of, a first magnet or a first electromagnet, configured to be concentrically engaged with the upper plate;
an upper internal core;
a coil; and
an upper plate housing configured to receive the upper internal core and the coil, the upper plate housing being coupled to at least one of, the first magnet or the first electromagnet,
wherein, when power is supplied to the system, an induced current is generated in the upper internal core and the coil to create a first centrifugal magnetic field configured to rotate the upper plate and at least one of, the first magnet or the first electromagnet.

2. The weight control system according to claim 1, further comprising:
a spring positioned on an upper portion of the system;
an upper damper; and
a spring guide fixing plate connected to the lower portion of the system through the upper damper,
wherein the spring is fixed to the spring guide fixing plate.

3. The weight control system according to claim 2, further comprising:
a bottom plate in the lower portion; and
at least one of, a second magnet or a second electromagnet, positioned on the bottom plate,
wherein the first centrifugal magnetic field is configured to rotate at least one of, the second magnet or the second electromagnet, to create a second centrifugal magnetic field, and
wherein at least one of, a vibration force or a compression force, is applied to the spring through the upper damper due to an overlapping of the first and the second centrifugal magnetic fields.

4. The weight control system according to claim 3, wherein the upper damper comprises a piezoelectric element attached thereto, the piezoelectric element being configured to produce electrical energy when at least one of, the vibration force or the compression force, is applied to the spring through the upper damper.

5. The weight control system according to claim 1, further comprising:
a control box having
a battery; and
a sensor configured to automatically turn on or turn off the system depending on a battery level.

6. The weight control system according to claim 5, wherein the control box further comprises:
a central processing unit configured to automatically control an electric power level of the battery, and configured to start charging the battery, to turn on a red light emitting diode (LED) light, and to generate a warning sound when the electric power level of the battery is lower than a predetermined level.

7. The weight control system according to claim 6, wherein at least one of, a text, an e-mail, or a voice message, is sent to a mobile phone or a reachable device designated by a user to notify the user that the battery is being charged.

8. The weight control system according to claim 5, wherein the control box further comprises:
a central processing unit configured to automatically control an electric power level of the battery, and configured to turn on a green LED light when charging of the battery is completed.

9. The weight control system according to claim 8, wherein at least one of, a text, an e-mail, or a voice message, is sent to a mobile phone or a reachable device designated by a user to notify the user that the charging of the battery is completed.

10. The weight control system according to claim 1, further comprising:
a control box configured to allow remote control by a user to turn on or turn off the system.

11. A weight control method using a natural frequency of resonance, the method comprising:
providing a spring;
generating two or more magnetic fields having different directions, the two or more magnetic fields being configured to interrupt and overlap each other to generate an upward force; and
controlling a weight of an object by applying the upward force to the spring to lift the weight of the object.

12. The weight control method according to claim 11, further comprising:
providing an internal core and a coil,
wherein the two or more magnetic fields include a first centrifugal magnetic field generated by an induced current that flows through the internal core and the coil in response to a power supply and a second centrifugal magnetic field is generated by at least one of a magnet or an electromagnet that is rotated by a centrifugal force caused by the first centrifugal magnetic field.

13. The weight control method according to claim 12, further comprising:
applying at least one of, a vibration force or a compression force, to the spring due to an overlapping of the first and the second magnetic fields.

14. The weight control method according to claim 13, further comprising:
providing at least one piezoelectric element connected to the spring,
wherein, when the at least one piezoelectric element receives at least one of, the vibration force or the compression force, applied to the spring, electrical energy is produced.
